(19) United States
(12) Patent Application Publication
(10) Pub. No.: US 2006/0273862 A1
(43) Pub. Date: Dec. 7, 2006

(54) Semiconductor thin film manufacturing method, electronic device, and liquid crystal display device

(75) Inventor: Tadashi Shimmura, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/446,247

(22) Filed: Jun. 5, 2006

(30) Foreign Application Priority Data
Jun. 6, 2005 (JP) 2005-166182

(51) Int. Cl. H01P 1/32

(52) U.S. Cl. 333/24.1

(57) ABSTRACT

A semiconductor thin film is manufactured by forming a first foundation layer on a substrate; making recesses in and raised parts on the first foundation layer; forming a second foundation layer on the first foundation layer, the second foundation layer extending over the recesses and raised parts of the first foundation layer, having heat conductivity which is different from heat conductivity of the first foundation layer, and having a flat surface; forming a semiconductor thin film on the second foundation layer; and illuminating energy beams onto the semiconductor thin film, and crystallizing the semiconductor thin film using the recesses and the raised parts of the first foundation layer and a part of the second foundation layer as crystal producing nucleuses.

### CROSS REFERENCE TO RELATED APPLICATIONS

This application is based upon and claims the benefit of the priority from prior Japanese Patent Application No. 2005-166182 filed on Jun. 6, 2005, the entire contents of which are incorporated by reference herein

### BACKGROUND OF THE INVENTION

1. Field of the Invention

The present invention relates to a semiconductor thin film manufacturing method, an electronic device, and a liquid crystal display device, and more particularly relates to a crystalline semiconductor thin film manufacturing method, an electronic device and a liquid crystal display device constituted by the semiconductor thin films manufactured by the method.

2. Description of the Related Art

Japanese Patent Laid-Open Publication No. 2004-119518 discloses a method of manufacturing a crystalline semiconductor thin film having high carrier mobility. In the method, an amorphous semiconductor thin film is deposited on an insulating substrate. Energy beams are illuminated onto the amorphous semiconductor thin film in order to change amorphous properties to crystal properties, so that a crystalline semiconductor thin film will be formed. Specifically, the amorphous semiconductor thin film is fused by the energy beams, is solidified, and is changed into the crystalline semiconductor thin film.

The foregoing method is applied to manufacturing a thin film transistor (TFT) of a liquid crystal display device (liquid crystal display panel). Specifically, an amorphous Si (silicon) thin film is formed on a transparent quartz substrate via an insulating layer. Laser beams are illuminated onto the amorphous silicon (Si) thin film, which is changed to a polycrystalline Si thin film. The polycrystalline Si thin film is used as a source region, a channel forming region or a drain region of a thin film transistor.

It seems that the following problems remain unsolved in the foregoing method of manufacturing the crystalline semiconductor thin film and the method of manufacturing the liquid crystal display device. When energy beams are illuminated onto the amorphous Si film placed on the flat transparent quartz substrate, heat generated by the energy beams are uniformly transmitted into the quartz substrate. Therefore, it is impossible to control, in the quartz substrate, positions of crystal producing nucleuses, and a speed at which the amorphous Si thin film is solidified. In short, it is impossible to control positions and diameters of Si crystal grains in the crystallized Si thin film.

The positions of and the number of Si crystal gains are different in source regions, channel forming regions and drain regions of each thin film transistor of one liquid crystal display device. This will result in variations in electric properties such as carrier mobility, threshold voltages, and leak currents. Further, positions of, quantities of and diameters of Si crystal gains are different in source regions, channel forming regions and drain regions of each thin film transistor in each production lot. This also may lead to variations in the electric properties such as carrier mobility, threshold voltages, and leak currents. The variations of the electric properties will adversely affect performance of the liquid crystal display device.

### BRIEF SUMMARY OF THE INVENTION

According to a first aspect of the embodiment of the invention, there is provided a method of manufacturing a semiconductor thin film. The method includes forming a first foundation layer on a substrate; making recesses in and raised parts on the first foundation layer; forming a second foundation layer on the first foundation layer, the second foundation layer foundation extending over the recesses and raised parts of the first foundation layer, having heat conductivity which is different from heat conductivity of the first foundation layer, and having a flat surface; forming a semiconductor thin film on the second foundation layer; and illuminating energy beams onto the semiconductor thin film, and crystallizing the semiconductor thin film using the recesses and the raised parts of~the first foundation layer and a part of the second foundation layer as crystal producing nucleuses.

In accordance with a second aspect of the embodiment, there is provided an electronic device, which includes a substrate; a foundation formed on the substrate and having a plurality of crystal producing nucleuses arranged in the shape of a matrix; and transistors using semiconductor thin films as operation regions, the semiconductor thin films being crystalline and provided at the crystal producing nucleuses on the foundation.

According a final aspect of the embodiment, there is provided a liquid crystal display device, which includes a transparent substrate; a foundation formed on the transparent substrate and having a plurality of crystal producing nucleuses arranged in the shape of a matrix; and transistors using semiconductor thin films as channel forming regions, the semiconductor thin films being crystalline and provided at the crystal producing nucleuses on the foundation layer.

### BRIEF DESCRIPTION OF SEVERAL VIEWS OF THE DRAWINGS

FIG. 1 is a cross section of an essential part of a liquid crystal display device according to one example of the invention;

FIG. 2 is an exploded perspective view of the liquid crystal display device of FIG. 1;

FIG. 3 is a cross section of the liquid crystal display device (semiconductor thin film) in a first manufacturing process;

FIG. 4 is a cross section of the liquid crystal display device in a second manufacturing process;

FIG. 5 is a cross section of the liquid crystal display device in a third manufacturing process;

FIG. 6 is a cross section of the liquid crystal display device in a fourth manufacturing process; and

FIG. 7 is a cross section of the liquid crystal display device in a fifth manufacturing process.

### DETAILED DESCRIPTION OF THE INVENTION

In a first example, the invention is applied to a liquid crystal display device shown in the drawings.

[Structure of Liquid Crystal Display Device]

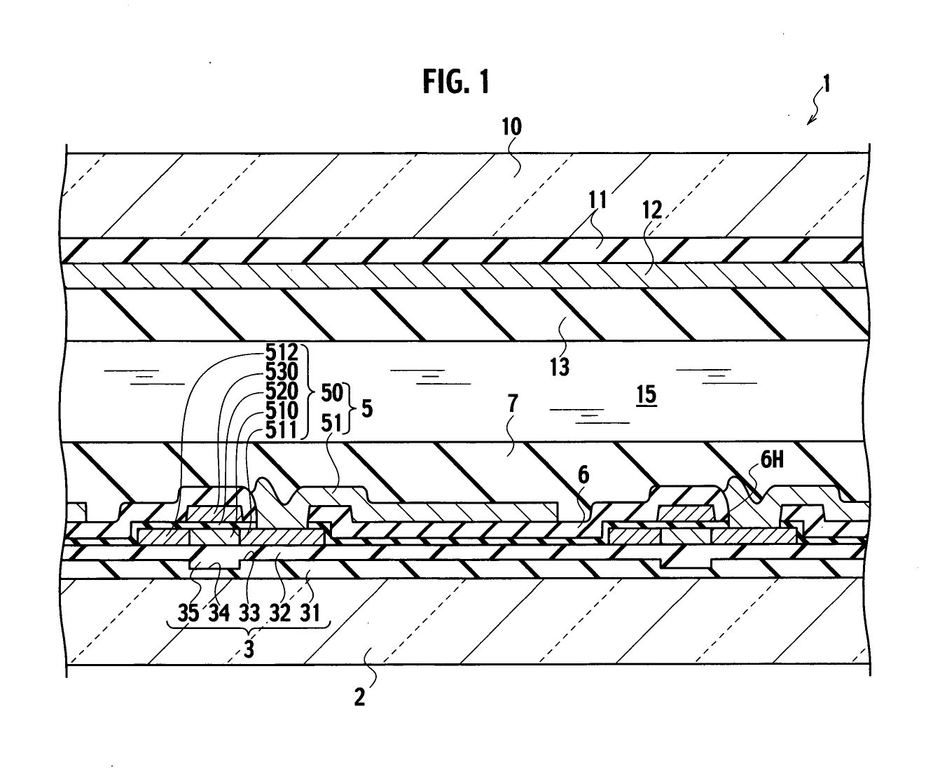

Referring to FIG. 1, a liquid display device 1 includes a first transparent substrate 2, a foundation 3, and thin film transistors (TFT) 50. The foundation 3 is placed on a front surface (an upper surface in FIG. 1) of the first transparent substrate 2, and has a plurality of crystal producing nucleus 35 which are arranged in the shape of a matrix. Each thin film transistor 50 has the channel forming region 510. The channel forming regions 510 has been formed in the semiconductor thin film with the crystallinity. The channel forming regions 510 are placed in the region in proportion to crystal producing nucleus 35 formed over the foundation 3. Further, the liquid crystal device 1 includes pixel electrodes 51, a liquid crystal 15, a common pixel electrode 12, and a second transparent substrate 10.

The first and second transparent substrates 2 and 10 are transparent quartz substrates, for instance. The liquid crystal 15 is enclosed between the first and second transparent substrates 2 and 10, which are placed to face with each other.

The thin film transistors 50 are placed on the first transparent substrate 2 via the foundation 3, and are arranged in the matrix shape. In this example, one pixel electrode 51 is provided for each thin film transistor 50, for instance. Each thin film transistor 50 and each pixel electrode 51 are electrically connected in series, and constitute one pixel 5.

Each thin film transistor 50 includes the channel forming region 510, a first main electrode region 511, a second main electrode region 512, a gate insulator 520 on the channel forming region 510, and a control electrode (gate electrode) 530 on the gate insulator 520. The first main electrode region 511 is positioned on one end (at the right side in FIG. 1) of the channel forming region 510, and serves as a source region. The second main electrode region 512 is present on the other end (at the left side in FIG. 1) of the channel forming region 510, and serves as a drain region.

The channel forming region 510 and the first and second main electrode regions 511 and 512 are made of crystalline semiconductor films, more specifically polycrystalline Si thin films. The polycrystalline Si thin films are prepared by making amorphous Si thin films in the manufacturing process of the liquid crystal display device 1, and crystallizing the amorphous Si thin films. In this case, the crystal producing nucleuses 35 in the foundation 3 are used as cores for radially crystallizing the amorphous Si thin films.

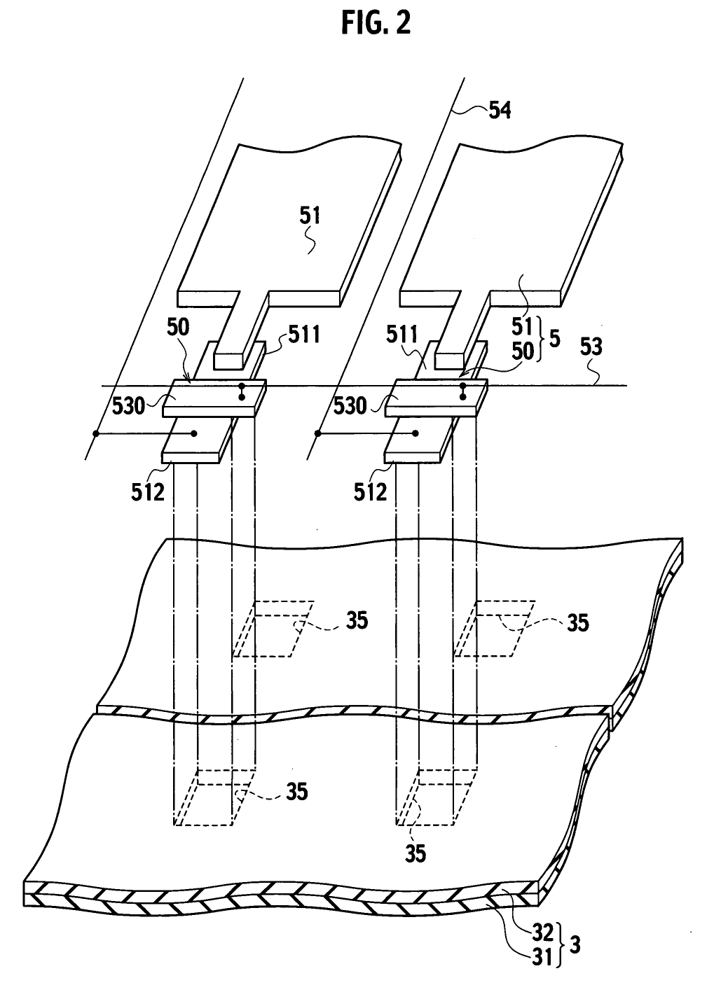

Referring to FIG. 1 and FIG. 2, the foundation 3 includes a first foundation layer 31 having raised parts 33 and recesses 34, and second foundation layer 32 having a flat surface. The second foundation layer 32 is placed on the first foundation layer 31. The recesses 34 of the first foundation layer 31 are in the shape of grooves or holes (such as through holes or holes having bottoms) while the raised parts 33 are present where no recesses 34 are made, and are high compared to the recesses 34 when the bottoms of the recesses 34 are considered to be a base level. Thermal conductivity of the first foundation layer 31 is higher than that of the second foundation layer 32. The first foundation layer 31 is thick while the second foundation layer 32 is thin at the raised parts 33 of the foundation 3. On the contrary, the first foundation layer 31 is thin while the second foundation layer 32 is thick at the recesses 34. A total of thermal conductivity of the recesses 34 of the second foundation layer 32 is higher than a total of thermal conductivity of the raised parts 33 of the first foundation layer 31. The crystal producing nucleuses 35 are present at areas where the foundation 3 is thin because of the recesses 34 of first foundation layer 31 and is thick because of the raised parts 34 of the second foundation layer 32.

The crystallization of the amorphous Si film is started at the crystal producing nucleuses 35. There is no grain boundary in the channel forming region 510 of the thin film transistor 50. Each crystal producing nucleus 35 is used to crystallize the channel forming region 510 as one crystal grain. The crystal producing nucleus 35 is provided for each thin film transistor 50, especially for each channel forming region 510, and is preferably smaller than the channel forming region 510, or is as large as the thin film transistor 50. In this example, the crystal producing nucleus 35 is square, but may be rectangular, pentagonal, polygonal or circular.

The gate insulator 520 of the thin film transistor 50 is placed on the channel forming region 510 which is made of an oxide Si film, for instance. The control electrode 530 is placed on the channel forming region 510 via the gate insulator 520, and is made of a polycrystalline Si film, a refractory metal film such as tungsten (W) and molybdenum (Mo), a silicide film which is a compound of polycrystalline Si and refractory metal, or a combined film of a refractory metal placed on the polycrystalline Si film or silicide film.

The pixel electrode 51 is placed on an interlayer dielectric 6, and is electrically connected to the first main electrode region 511 of the thin film transistor 50 via a connection hole 6H. The pixel electrode 51 is preferably made of an ITO film.

As schematically shown in FIG. 2, the control electrodes 530 of the thin film transistors 50 are arranged in the matrix shape, and are electrically connected to vertical scanning lines (gate signal lines) 53. Each vertical scanning line 53 is flush with and integral with each control electrode 530. Further, second main electrode regions 512 of the thin film transistors 50 are electrically connected to horizontal scanning lines (image signal lines) 51. The horizontal scanning lines 51 are positioned above the control electrodes 530.

Referring to FIG. 1, a protection film 7 is provided on the pixels 5, specifically, on the pixel electrodes 51. The liquid crystal 11 is placed on the protection film 7.

A further foundation 11 is provided on an under side of the second transparent electrode 10 as shown in FIG. 1. The common pixel electrode 12 is placed on the foundation 11, and is made of the ITO film similarly to the pixel electrode 51 described above. The common pixel electrode 12 is covered by a protector film 13, which encloses the liquid crystal 15 together with the protector film 7.

[Method of Manufacturing Liquid Crystal Display Device]

The following describes a method of manufacturing the liquid crystal display device 1, and more particularly describes a method of fabricating a semiconductor thin film which is used to make the channel forming region 510, and the first and second main electrode regions 511 and 512 of the thin film transistor 50.

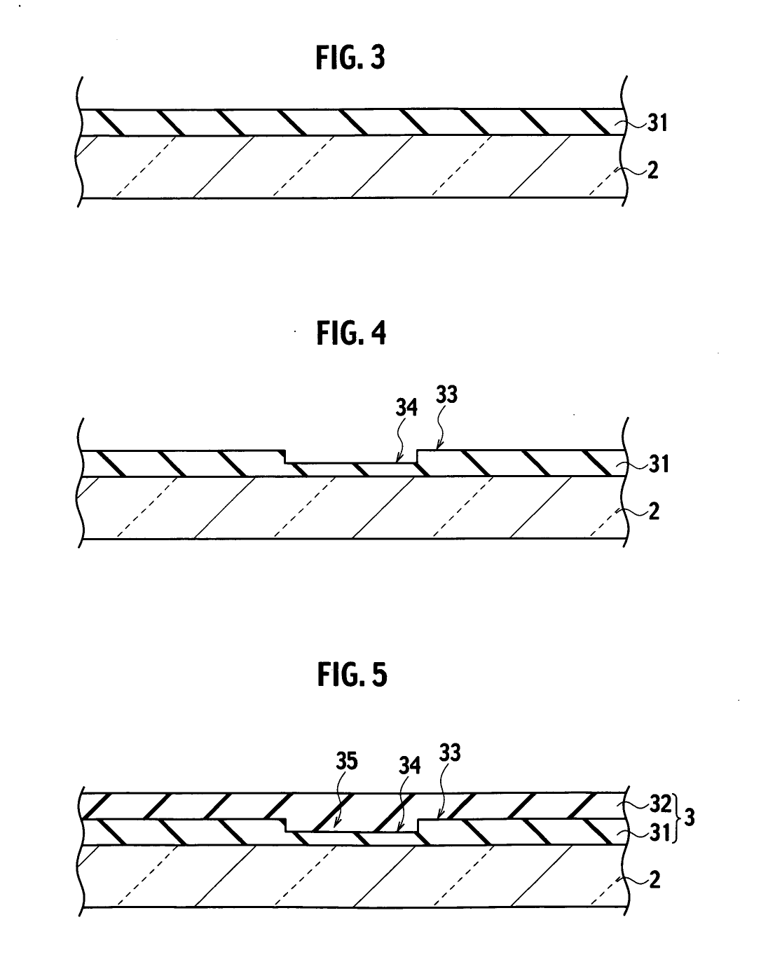

The first transparent substrate 2 is prepared first of all. Referring to FIG. 3, the first foundation layer 31 is applied onto the first transparent substrate 2. For instance, the first foundation 31 is preferably made of an oxide silicon film, and is 50 nm to 100 nm thick.

A plurality of recesses 34 are made in the first foundation layer 31 at positions where the channel forming regions 510 (shown in FIG. 1 and FIG. 2) of the thin film transistor 50 will be formed. The recesses 34 are arranged in the shape of a matrix. Specifically, the first foundation layer 31 is etched using a photolithographic mask. The first foundation layer 31 has a plurality of raised parts 33 in addition to the recesses 34.

Alternatively, the recesses 34 may be formed by using a die assembly which has a plurality of raised parts in the reverse shape of the recesses 34. While being heated, the heated die assembly is pressed onto the first foundation layer 31. The die assembly may be made of a very hard material such as silicon carbide, diamond, and nickel.

Thereafter, the second foundation layer 32 (shown in FIG. 5) is deposited by the chemical-vapor-deposition (CVD), sputtering or the like. The second foundation layer 32 is preferably made of a silicon nitride film having thermal conductivity which differs from that of the first foundation layer 31. The second foundation layer 32 is 50 nm to 100 nm thick, for instance. Alternatively, an insulating film may be applied onto the first foundation layer 31. In such a case, the second foundation layer 32 may be flattened while it is being applied. Therefore, no special flattening process will be necessary.

Referring to FIG. 5, the second foundation layer 32 is polished and flattened by the chemical-mechanical-polishing (CMP) process. In this way, the foundation 3 including the first and second foundation layers 31 and 32 is completed, so that the crystal producing nucleuses 35 will be constituted by the first and second foundation layers 31 and 32.

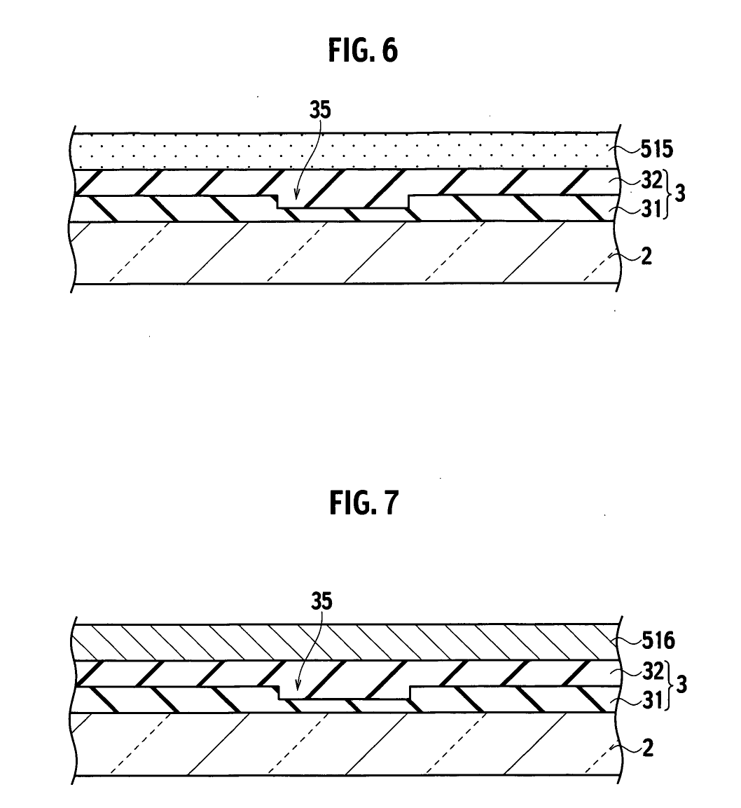

As shown in FIG. 6, the amorphous semiconductor film 515 is formed on the foundation 3 (i.e., the second foundation layer 32). The amorphous semiconductor thin film 515 is preferably made of an amorphous silicon film prepared by the CVD process.

Energy beams are illuminated in order to fuse the amorphous semiconductor thin film 515. For this purpose, the excimer lasers are utilized. Heat of the fused amorphous semiconductor thin film 515 is transmitted to the first transparent substrate 2, and the amorphous semiconductor thin film 515 is cooled. In this state, the periphery of the crystal producing nucleuses 35 in the foundation 3 is designed to be cooled at an accelerated speed. Therefore, the amorphous semiconductor thin film 515 is radially crystallized around the crystal producing nucleuses 35, so that the crystallized semiconductor thin film 516, i.e., the polycrystalline silicon film, will be formed. While making the crystallized semiconductor thin film 516, the diameter of the crystal grains can be controlled on the basis of the size of the crystal producing nucleuses 35, depth of the recesses 34, heat conductivity and thickness of the first foundation layer 31, heat conduction and thickness of the second foundation layer 32, crystallizing speed, and so on. It is therefore possible to prevent the formation of grain boundaries in the channel forming region 510 of the thin film transistor 51. This applies to a plurality of thin film transistors 50.

Next, each of the gate insulator 520 and the control electrode 530 is formed in order on the surface of the crystallized semiconductor thin film 516. Afterwards, the first main electrode region 511 and the second main electrode region 512 are formed in the crystallized semiconductor thin film 516. With this process, the channel forming region 510 is formed from crystallized semiconductor thin film 516 between the first main electrode region 511 and the second main electrode region 512. At this stage, the thin film transistor 50 is completed (see FIG. 1).

The interlayer dielectric 6 is formed over the thin film transistor 50. The connection hole 6H is made in the interlayer dielectric 6. Further, the pixel electrode 51 to be connected to the first main electrode region 511 is made on the interlayer dielectric 6 (see FIG. 1). The pixel 5 constituted by a series circuit between the thin film transistor 50 and the pixel electrode 51 is thus completed. Thereafter, the protector film 7 is made over the pixel 5.

The second transparent substrate 10 is prepared. The foundation 11, common pixel electrode 12 and protector film 13 are formed on the second transparent substrate 10 one after the other.

The first and second transparent substrates 2 and 10 are placed to face with each other. Then, the liquid crystal 15 is enclosed between them. Thus, the liquid crystal display device 1 is completed.

In the foregoing method of manufacturing the liquid crystal device 1, i.e., the semiconductor thin film, the crystal producing nucleuses 35 are formed in the foundation 3. The amorphous semiconductor thin film 515 on the foundation 3 is crystallized using the crystal producing nucleuses 35 as the cores, so that the crystallized semiconductor thin film 516 is made. Therefore, the positions and diameters of crystal grains of the crystallized semiconductor thin film 516 can be easily controlled in the first transparent substrate 2.

With the liquid crystal display device 1, the crystal producing nucleuses 35 are present in the foundation 3 on which the thin film transistor 50, and specifically, the channel forming region 510, is formed. Each channel forming region 510 is radially crystallized around each crystal producing nucleus 35, so that no grain boundary will be present in the channel forming region 510. In other words, each channel forming region 510 is made of one crystal grain. Therefore, the thin film transistor 50 can assure reliable volt-ampere properties, which is effective in stabilizing display performance of the liquid crystal display device 1.

[Other Examples]

Although the invention has been described with reference to the specific example thereof, it will be understood by those skilled in the art that various modifications are possible without departing from the spirit of the present invention. The recesses 34 in the foundation 3 are used as the crystal producing nucleuses 35. Alternatively, the raised parts 33 may be used as the crystal producing nucleuses 35. In such a case, the thermal conductivity of the first foundation layer 31 is designed to be higher than that of the second foundation layer 32. A manufacturing method in this modified example is the same as that described above.

The foundation 3 may be constituted by three or more layers. In such a case, the two lower layers may be used to form crystal producing nucleuses 35.

Further, the present will be applicable not only to the liquid crystal display device 1 but also to transistors which use crystalline semiconductor thin films as operating regions, e.g., logics in which transistors on SOI (silicon on insulator) substrates are integrated, electronic devices provided with memories and so on. Still further, the invention is applicable to bipolar transistors, resistance elements, capacity elements, or the like.

As described above, the invention can provide the semiconductor thin film manufacturing method, in which positions and diameters of crystal grains in the substrate can be easily controlled.

Still further, the invention can provide the electronic device or the liquid crystal display device, in which the transistors uses the semiconductor thin films as operating regions, are relatively free from variations of electric properties, and assure good controllability.

What is claimed is:

1. A method of manufacturing a semiconductor thin film, the method comprising:
forming a first foundation layer on a substrate;
making recesses in and raised parts on the first foundation layer;
forming a second foundation layer on the first foundation layer, the second foundation layer extending over the recesses and raised parts of the first foundation layer, having heat conductivity which is different from thermal conductivity of the first foundation layer, and having a flat surface;
forming a semiconductor thin film on the second foundation layer; and
illuminating energy beams onto the semiconductor thin film, and crystallizing the semiconductor thin film using the recesses and the raised parts of the first foundation layer and a part of the second foundation layer as crystal producing nucleuses.

2. The method of claim 1, wherein a die assembly is pressed onto the first foundation layer in order to make the recesses and the raised parts in and on the first foundation layer, and the die assembly has recesses and raised parts on a surface thereof.

3. The method of claim 1, wherein a coating material is applied onto the recesses and raised parts of the first foundation layer in order to make the second foundation layer, which flattens a surface of the first foundation layer.

4. The method of claim 2, wherein a coating material is applied onto the recesses and raised parts of the first foundation layer in order to make the second foundation layer, which flattens a surface of the first foundation layer.

5. The method of claim 1, wherein the second foundation layer has higher thermal conductivity than thermal conductivity of the first foundation layer, and the raised parts of the first foundation layer and the second foundation layer thereon form the crystal producing nucleuses.

6. The method of claim 1, wherein the second foundation layer has lower thermal conductivity than thermal conductivity of the first foundation layer, and the raised parts of the first foundation layer and the second foundation layer thereon form the crystal producing nucleuses.

7. The method of claim 1, wherein an insulating film of coating type is applied as the second foundation layer.

8. The method of claim 1, wherein an oxide silicon film of coating type is applied as the first foundation layer, and a nitride silicon film of coating type is applied as the second foundation layer.

9. An electronic device comprising:
a substrate;
a foundation formed on the substrate and having a plurality of crystal producing nucleuses arranged in the shape of a matrix; and
transistors using semiconductor thin films as operation regions, the semiconductor thin films being crystalline and provided at the crystal producing nucleuses on the foundation.

10. The electronic device of claim 9, wherein the foundation includes a first foundation layer with raised parts and recesses and a second layer having thermal conductivity different from thermal conductivity of the first foundation layer and extending over the raised parts and recesses of the first layer, and the raised parts and recesses of the first foundation layer constitute the crystal producing nucleuses.

11. The electronic device of claim 10, wherein the second foundation layer has higher thermal conductivity than thermal conductivity of the first foundation layer, and the crystal producing nucleuses are constituted by the raised parts of the first foundation layer and the second layer extending over the first layer.

12. The electronic device of claim 10, wherein the second foundation layer has lower thermal conductivity than thermal conductivity of the first foundation layer, and the crystal producing nucleuses are constituted by the recesses of the first foundation layer and the second foundation layer extending over the first layer.

13. The electronic device of claim 10, wherein a size of each crystal producing nucleus is equal to or smaller than a size of the operation region of the transistor.

14. The electronic device of claim 10, wherein the operation region of the transistor serves as a channel forming region.

15. A liquid crystal display device comprising:
a transparent substrate;
a foundation formed on the transparent substrate and having a plurality of crystal producing nucleuses arranged in the shape of a matrix; and
transistors using semiconductor thin films as channel forming regions, the semiconductor thin films being crystalline and provided at the crystal producing nucleuses on the foundation layer.

16. The liquid crystal display device of claim 15, wherein the foundation includes a first foundation layer having recesses and raised parts and a second foundation layer having thermal conductivity different from thermal conductivity of the first foundation layer and a flat surface; the second foundation layer extends over the recesses and raised parts of the first foundation layer; and the recesses and raised parts of the first foundation layer constitute the crystal producing nucleuses.

17. The liquid crystal display device of claim 16, wherein the second foundation layer has higher thermal conductivity than thermal conductivity of the first foundation layer, and the crystal producing nucleuses are constituted by the raised parts of the first foundation layer and the second foundation layer extending over the first foundation layer.

18. The liquid crystal display device of claim 16, wherein the second foundation layer has lower thermal conductivity than thermal conductivity of the first foundation layer, and the crystal producing nucleuses are constituted by the recesses of the first foundation layer and the second foundation layer extending over the first foundation layer.

19. The liquid crystal display device of claim 15, wherein each crystal producing nucleus has a two-dimensional size which is equal to or smaller than a two-dimensional size of the channel forming region of the thin film transistor.

20. The liquid crystal display device of claim 15, further comprising:
vertical scanning lines electrically connected to gate electrodes of the thin film transistor;
horizontal scanning lines connected to one main electrode of the thin film transistor;
pixel electrodes connected to the other main electrode of the thin film transistor;
a common pixel electrode placed to face with the pixel electrodes; and
a liquid crystal enclosed between the pixel electrodes and the common pixel electrode.
